(19) United States
(12) Patent Application Publication
(10) Pub. No.: US 2026/0349697 A1
(43) Pub. Date: Nov. 5, 2026

(54) METHOD FOR UPDATING A CONTROL DEVICE OF A VEHICLE

(71) Applicant: AUDI AG, Ingolstadt (DE)

(72) Inventors: Christian GÜNTER, Boehmfeld (DE); Karsten SCHMIDT, Ingolstadt (DE)

(73) Assignee: AUDI AG, Ingolstadt (DE)

(21) Appl. No.: 19/118,611

(22) PCT Filed: Sep. 28, 2023
(86) PCT No.: PCT/EP2023/076945

§ 371 Date: Apr. 4, 2025

(30) Foreign Application Priority Data
Oct. 5, 2022 (DE) 10 2022 125 711.8

(51) Int. Cl. G06F 8/65

(52) U.S. Cl. CPC G06F 8/65

(57) ABSTRACT

Method for updating a control device of a vehicle, in which software updating the control device is loaded into an execution environment of the control device, and control device for a vehicle.

### CROSS-REFERENCE TO RELATED APPLICATIONS

This application is a U.S. national stage of International Application No. PCT/EP2023/076945, filed on Sep. 28, 2023, which claims the priority benefit of German Patent Application No. 10 2022 125 711.8 filed on Oct. 5, 2022. Both the International Application and the German Patent Application are incorporated by reference herein in their entirety.

### BACKGROUND

### 1. Field

Examples of an invention relate to a method for updating a control device of a vehicle, in which software updating the control device is loaded into an execution environment of the control device. The examples of the invention moreover relate to a control device for a vehicle.

### 2. Description of the Related Art

Methods of the type mentioned above belong in different configurations to the prior art and are used to put a control device of a vehicle in a new state by means of new software. The new software is loaded into an execution environment of the control device and updates the control device. The execution environment comprises a storage area and a processor, associated with the storage area, of the control device, or a core, associated with the storage area, of a processor of the control device.

DE 10 2012 211 591 A1 discloses, for example, an updating method for a control device of a vehicle, in which an engine control device of the vehicle is updated. The updating of the engine control device comprises enabling or activation of the engine control device for a different engine power, wherein the enabling or activation comprises loading a new control device code or loading new application data into a specific storage area of the control device. The engine control device is updated by a producer of the control device or by a software developer other than the producer of the control device.

For example, the company “BDperformance” offers an updating method called ECUflash® for a control device of a motorcycle, in which the control device is updated by means of a flash tool by storing an optimized configuration file in the control device. Switching between an original configuration file and the optimized configuration file is possible at any time (see<URL: https://ecuflash.de>).

A control device of the vehicle provided by a manufacturer of a vehicle can of course also be updated by it being replaced by a replacement device provided by a third-party manufacturer. An exemplary replacement device is provided by the rusEFI group as part of an open-source project (see <URL: https://rusefi.com>).

EP 3 333 748 A1 discloses an updating method for a control device of a vehicle, in which the control device is started up in a neutral operating state in order to set one of two configured operating states. Subsequent start-up of the control device in a first configured operating state allows one-off switching into the second configured operating state. Subsequent start-up of the control device in a second configured operating state does not allow switching into the first configured operating state.

If the control device provides multiple functions, in particular functions of different safety levels (ASIL), for the vehicle, it must be ensured that a first function is not affected by a fault of a second function.

DE 10 2014 201 682 A1 discloses such an operating method for a control device of a vehicle. In the method, each core of a processor of the control device is associated with an independent separate storage area with software installed therein. Each core of the processor runs only the software installed in the associated storage area. Updating of software of a storage area or a runtime error of the software of the storage area does not affect the running of software of other storage areas.

DE 10 2019 200 812 A1 also discloses an operating method for a control device of a vehicle, in which a first software module implementing a primary function of the control device and a second software module implementing an auxiliary function of the control device are performed in different hardware partitions separate from one another. An error in the auxiliary function does not affect the primary function.

Updating a control device is usually exclusively undertaken by an OEM (Original Equipment Manufacturer) of the control device. In this way, the risk is minimized that a function of the control device is affected by faulty software or by incompatible software. However, in this way software developers other than the manufacturer of the control device are excluded from updating the control device.

Software provided by such a software developer is referred to below as free software, whilst software provided by the manufacturer of the control device is referred to as OEM software.

### SUMMARY

An example object of the invention may be a method for updating a control device of a vehicle which makes possible loading of free software into the control device and ensures a statutory minimal functionality of the control device. Another example object of the invention may be to provide a control device for a vehicle.

A subject of examples of the invention is a method for updating a control device of a vehicle, in which software updating the control device is loaded into an execution environment of the control device. In the updating method, the control device is transferred into an updated, i.e. new state by loading new software. The loading of the new software into the control device can take place in any known fashion. The vehicle can in particular take the form of a car.

According to the examples of the invention, a configuration of the control device is transferred from a closed configuration into an open configuration and free software is loaded into a free execution environment of the open configuration as the software updating the control device. The updating method changes the configuration of the control device. The closed configuration corresponds to a delivery state of the control device. It allows only an OEM (Original Equipment Manufacturer) of the control device to update the control device by OEM software provided by the manufacturer.

The control device usually maintains the closed configuration during the warranty period of the control device or the vehicle.

In contrast, the open configuration allows the loading of free software into the control device, specifically into a free execution environment of the open configuration of the control device. The closed configuration can already comprise the free execution environment.

It should be noted that the transfer from the closed configuration into the open configuration can require a corresponding request of an owner of the vehicle. If the manufacturer of the control device agrees to the request, successful authentication of the owner can furthermore be required in a manner known per se, for example by an identity card and/or a vehicle registration document.

The transfer may comprise creating the free execution environment and/or maintaining an OEM execution environment of the closed configuration and/or a security execution environment of the closed configuration. In other words, the control device comprises the free execution environment only after the transfer of the closed configuration into the open configuration. In this way, a storage space of the control device available in the closed configuration is not restricted by the free execution environment.

In contrast, the OEM execution environment and/or the security execution environment belong both to the closed configuration and to the open configuration. The maintenance can comprise changing the OEM execution environment and/or the security execution environment, for example a variable of the respective execution environment and/or software stored in the respective execution environment.

The free execution environment is advantageously created in a hardware partition, comprising the OEM execution environment, of the control device. Put simply, the free execution environment and the OEM execution environment belong to the same hardware partition. The two execution environments share the same microprocessor or microcontroller. In this way, software modules of the two execution environments can interact particularly simply.

The transfer ideally comprises loading OEM software with statutory minimal functionality into the OEM execution environment and/or moving OEM software with statutory minimal functionality from the OEM execution environment into the security execution environment. During the transfer of the closed configuration into the open configuration, the OEM software is loaded into the OEM execution environment of the open configuration. Alternatively or additionally, during the transfer, the OEM software stored in the OEM execution environment of the closed configuration is moved in particular partially into the security execution environment.

The OEM software ensures correct minimal functionality of the control device independently of free software loaded into the free execution environment. Without the free software, the control device can, after the transfer into the open configuration, have a restricted, i.e. reduced functionality compared with the closed configuration.

In one embodiment, the OEM execution environment protects the loaded OEM software from unauthorized changes or the security execution environment protects the moved OEM software from unauthorized changes. Protection of the OEM execution environment or the security execution environment can comprise any known ways which is suitable for preventing the unauthorized changing of the OEM software. The known ways include, for example, keys and certificates. Thanks to the protection, a software developer other than the manufacturer of the control device cannot change the OEM software. Consequently, the statutory minimal functionality of the control device continues to be ensured. The protection of the OEM execution environment or the security execution environment protects in particular safety-relevant functions of the vehicle.

The loaded OEM software can provide an interface for the free software loaded into the free execution environment. The interface allows the free software to interact with read-only access with the OEM software. For example, the free software can, via the interface, retrieve and use a distance traveled, i.e. the mileage of the vehicle, which is managed by the OEM software. However, the free software cannot manipulate the distance traveled. In this way, authenticity of the distance traveled of the vehicle continues to be secured. A specification, i.e. definition, of the interface is published by the manufacturer of the control device. The same can also apply for firmware of the control device.

In one example, the security execution environment provides in each case at least one key and/or one certificate for accessing the OEM execution environment or the free execution environment. The security execution environment (hardware security execution environment, HSEE) can, for example, take the form of a hardware security module (HSM) or a trusted execution environment (TEE). The security execution environment issues the keys and/or certificates required for the access.

A boot loader loaded into the free execution environment can load the free software. The boot loader loads the free software when the control device is restarted, as a result of which updating the control device is facilitated.

The transfer of the configuration is favorably recorded in an OEM database which is external with respect to the vehicle. The recording can take place automatically and comprises, for example, storage of the time of the transfer, and a list of free software loaded into the free execution environment. In this way, the OEM database allows retrieval at any time in order to establish a current configuration of the control device.

It should be understood that the described examples of the method can be applied simultaneously to a plurality of control devices of the vehicle, in particular to a group of interacting control devices of the vehicle.

A further subject of the examples of the invention is a control device for a vehicle which has a closed configuration. The closed configuration of the control device corresponds to a delivery state of the control device.

According to the examples of the invention, the control device may be configured to be updated by performing a method according to an example of the invention. The updating method changes the configuration of the control device and transfers the originally closed configuration into an open configuration. The open configuration allows loading of free software into the control device. OEM software which is also loaded into the control device during the transfer can ensure statutory minimal functionality of the control device.

An example essential advantage of the method according to the examples of the invention may be the fact that it is possible for a control device of a vehicle to be updated by free software and at the same time statutory functionality is ensured. In this way, the control device is programmable for software developers who are not a manufacturer of the control device.

### BRIEF DESCRIPTION OF DRAWINGS

The invention is illustrated schematically in the drawings on the basis of an example and is described further with reference to the drawings, in which:

FIG. 1 shows in a block diagram a control device according to an example of the invention for a vehicle in a closed configuration;

FIG. 2 shows in a block diagram the control device shown in FIG. 1 in an open configuration.

### DESCRIPTION

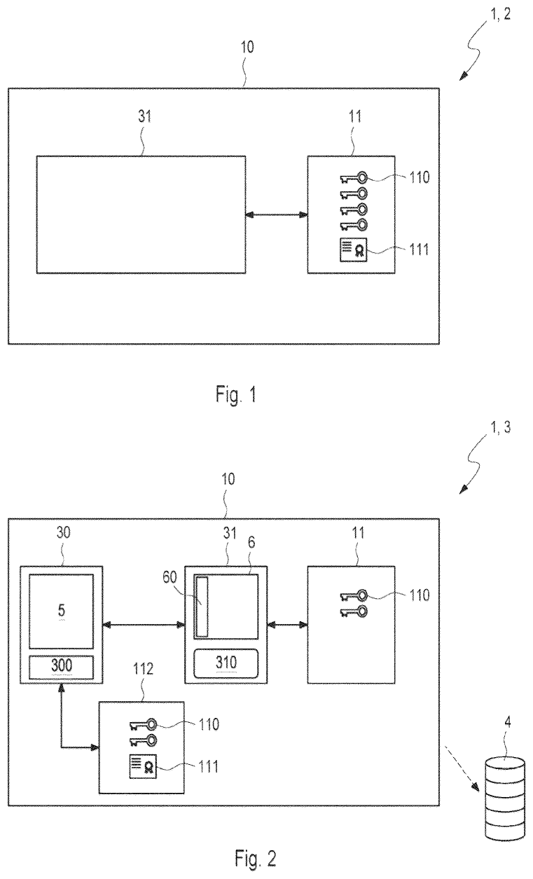

FIG. 1 shows in a block diagram a control device 1 according to an example of the invention for a vehicle (not illustrated) in a closed configuration 2. The control device 1 comprises a hardware partition 10 with an OEM execution environment 31 and a security execution environment 11. The security execution environment 11 is designed to provide at least one key 110 and/or one certificate 111, in particular a plurality of keys 110 and/or certificates 111.

The control device 1 has the closed configuration 2 and is configured to be updated by performing a method described below according to an example of the invention.

In the method for updating the control device 1 of the vehicle, software that is updating the control device 1 is loaded into an execution environment of the control device 1. The closed configuration 2 of the control device 1 is thus transferred into an open configuration 3 of the control device 1.

FIG. 2 shows in a block diagram the control device 1 shown in FIG. 1 in the open configuration 3. The transfer advantageously comprises creating a free execution environment 30 and/or maintaining an OEM execution environment 31 of the closed configuration 2 and/or a security execution environment of the closed configuration 2. The open configuration 3 comprises, after the transfer, the security execution environment 11, the OEM execution environment 31, and the free execution environment 30.

The OEM execution environment 31 can comprise a coordination module 310. The free execution environment 30 is for example created in the hardware partition 10, comprising the OEM execution environment 31, of the control device 1.

Free software 5 is loaded into the free execution environment 30 of the open configuration 3 as the software that is updating the control device 1. A boot loader 300 loaded into the free execution environment 30 expediently loads the free software 5.

The transfer comprises in particular loading of OEM software 6 with a statutory minimal functionality into the OEM execution environment 31 and/or moving OEM software 6 with a statutory minimal functionality from the OEM execution environment 30 into the security execution environment 11. The loaded OEM software 6 advantageously provides an interface 60 for the free software 5 loaded into the free execution environment 30. The OEM execution environment 31 can protect the loaded OEM software 6 from unauthorized changes. The security execution environment can protect the moved OEM software 6 from unauthorized changes.

The security execution environment 11 belonging to the closed configuration 2 and to the open configuration 3 can provide in each case at least one key 110 and/or one certificate 111 for accessing the OEM execution environment 31 or the free execution environment 30. Depicted is authorization 112 for the free execution environment, i.e. a subset of keys 110 and/or certificates 111 which the open execution environment 30 can access. It should be understood that the number and distribution of the depicted keys 110 and certificates 111 are only exemplary and do not imply a limitation.

The transfer can be recorded in an OEM database 4 which is external with respect to the vehicle.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

1 control device
10 hardware partition
11 security execution environment
110 key
111 certificate
112 authorization for the free execution environment
2 closed configuration
3 open configuration
30 free execution environment
300 boot loader
31 OEM execution environment
310 coordination module
4 OEM database
5 free software
6 OEM software
60 interface

1.-10. (canceled)

11. A method for updating a control device of a vehicle, comprising:
loading software to update the control device into an execution environment of the control device;
transferring a closed configuration of the control device into an open configuration of the control device; and
loading free software into a free execution environment of the open configuration to update the control device.

12. The method as claimed in claim 11, in which the transferring comprises creating the free execution environment and/or maintaining an OEM execution environment of the closed configuration and/or a security execution environment of the closed configuration.

13. The method as claimed in claim 12, in which the free execution environment is created in a hardware partition comprising the OEM execution environment of the control device.

14. The method as claimed in claim 13, in which the transferring comprises loading OEM software with statutory minimal functionality into the OEM execution environment and/or moving OEM software with statutory minimal functionality from the OEM execution environment into the security execution environment.

15. The method as claimed in claim 14, in which the OEM execution environment protects the loaded OEM software from unauthorized changes or the security execution environment protects the moved OEM software from unauthorized changes.

16. The method as claimed in claim 14, in which the loaded OEM software provides an interface for the free software loaded into the free execution environment.

17. The method as claimed in claim 15, in which the loaded OEM software provides an interface for the free software loaded into the free execution environment.

18. The method as claimed in claim 12, in which the security execution environment provides in each case at least one key and/or one certificate for accessing the OEM execution environment or the free execution environment.

19. The method as claimed in claim 11, in which a boot loader loaded into the free execution environment loads the free software.

20. The method as claimed in claim 11, in which the transferring is recorded in an OEM database which is external with respect to the vehicle.

21. A control device for a vehicle which has a closed configuration and is configured to be updated with the software by performing a method as claimed in claim 11.
